(19) United States
(12) Patent Application Publication
(10) Pub. No.: US 2012/0137990 A1
(43) Pub. Date: Jun. 7, 2012

(54) Systems and Methods for Liquid Vaporizers and Operations Thereof

(75) Inventors: Mark A. Buzanowski, Carrollton, TX (US); Gordon Smith, Denton, TX (US); Tim Shippy, Frisco, TX (US)

(73) Assignee: Peerless Mfg. Co., Dallas, TX (US)

(21) Appl. No.: 12/958,257

(22) Filed: Dec. 1, 2010

(51) Int. Cl. F22B 37/00; B23P 6/00; B21D 53/02

(52) U.S. Cl. 122/6 R; 29/890.03; 29/890.031

(57) ABSTRACT

A vaporizer including injection lances disposed within a vessel for injecting a substance such as liquid or heating media, into the vessel. The lances are configured for removal from the vessel through at least one of multiple orifices in the wall of the vessel. The orifices are configured to have lances extending through them into the vessel. The configuration of the vaporizer facilitates performing maintenance or making changes to the lances without the need to take the vaporizer out of service.

### TECHNICAL FIELD

The current disclosure generally relates to liquid vaporizers and specifically to systems and methods for liquid vaporizers and operating liquid vaporizers.

### BACKGROUND

A vaporizer is a device for transforming an element or compound from liquid phase to vapor phase (gas). Typically, transforming a liquid to gas involves the application of heat to the liquid. For example, the production of steam from water by heating the water to its boiling point is a well known vaporization process. In industrial plants, such as power plants, chemical plants, petrochemical plants, petroleum refineries, natural gas processing plants and the like, there may be aspects of the plants' process that vaporize liquid. Examples of vaporization processes at industrial plants include the production of steam from water, the vaporization of liquid ammonia, the vaporization of liquefied natural gas, and the like.

Because vapor usually rises when formed, vaporizer vessels are typically constructed as hollow cylindrical columns. Generally, heat is applied at the bottom of the column, while the liquid to be vaporized is injected above the source of heat. Once sufficient heat is applied to the liquid to raise it to at least its boiling point, the transformation from liquid to vapor takes place. The vapor rises and is withdrawn from the top of the column. The heat is often supplied by various types of heating media and is usually delivered through an inlet pipe. The liquid being vaporized is typically introduced into the vaporizer through rings that are concentric with the cylindrical column. These liquid injection rings are exposed to heat and materials that may be corrosive or may cause blockage during the operational life of the vaporizer. Depending on the location, blockages may significantly slow down the flow of liquid or completely block the flow of liquid into the vaporizer. Accordingly, the liquid injection rings may periodically require maintenance to clean and repair any blockages or corrosion. The vaporization unit will typically be taken out of service for this periodic maintenance to allow a repair crew to access the rings, usually, by opening the vessel. Taking equipment such as a vaporizer out of service at industrial plants, however, can be an expensive undertaking because it may reduce or stop overall production of a plant.

Another disadvantage with current vaporizers is that process changes that require modifications to the liquid delivery rings are difficult to implement. For example, if a process change requires that the vaporizer vaporize a more viscous liquid, it may be necessary to increase the diameter of the liquid delivery rings and/or increase the size of injection holes in the rings. Implementing this change would, again, require taking the vaporizer out of service.

### BRIEF SUMMARY

The current disclosure is directed to systems and methods for vaporizers and for operating vaporizers so that the vaporizers' fluid delivery apparatus can be maintained or changed without the need to take the vaporizers out of service. Various aspects of the disclosure also may improve the operations or increase the functionality of vaporizers.

Certain embodiments of the disclosure include a vaporizer having a vessel with a plurality of orifices in the wall of the vessel and a plurality of fluid delivery lances within the vessel. At least one of the lances is configured for removal from the vessel through at least one of the orifices. This orifice is configured to have the at least one lance extending through it into the vessel.

Other embodiments of the disclosure include a method of retrofitting a vaporizer that involves installing fluid delivery lances in a vessel. At least one of the lances is configured for removal from the vessel through at least one of a plurality of orifices in the wall of the vessel. This orifice is configured to have the at least one lance extending through it into the vessel.

Further embodiments of the disclosure include a method of making changes to equipment within a vaporizer. The method includes removing at least one lance disposed within the vaporizer through at least one of a plurality of orifices in a wall of the vaporizer. The orifice is configured to have the at least one lance extending through it into the vaporizer's vessel.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIGS. 1A and 1B show a prior art vaporizer;

FIG. 2A-2C show vaporizers configured according to select embodiments of the disclosure;

FIGS. 3A-3D show apparatus configured according to select embodiments of the disclosure.

FIG. 4A shows a vaporizer configured according to select embodiments of the disclosure;

FIGS. 4B-4E show lance configurations according to select embodiments of the disclosure;

FIG. 5 shows a functional block diagram according to select embodiments of the disclosure; and

FIG. 6 shows a functional block diagram according to select embodiments of the disclosure.

### DETAILED DESCRIPTION

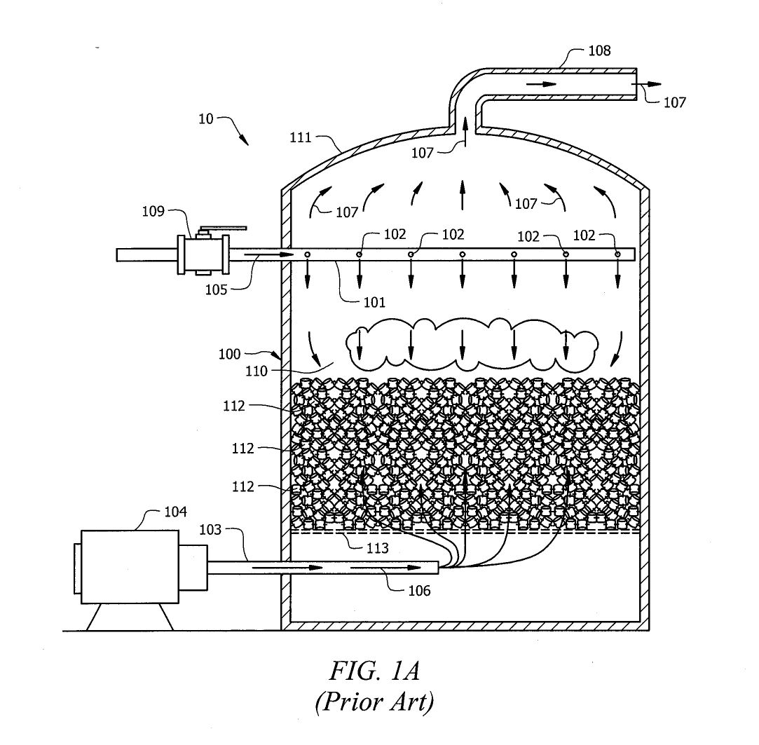

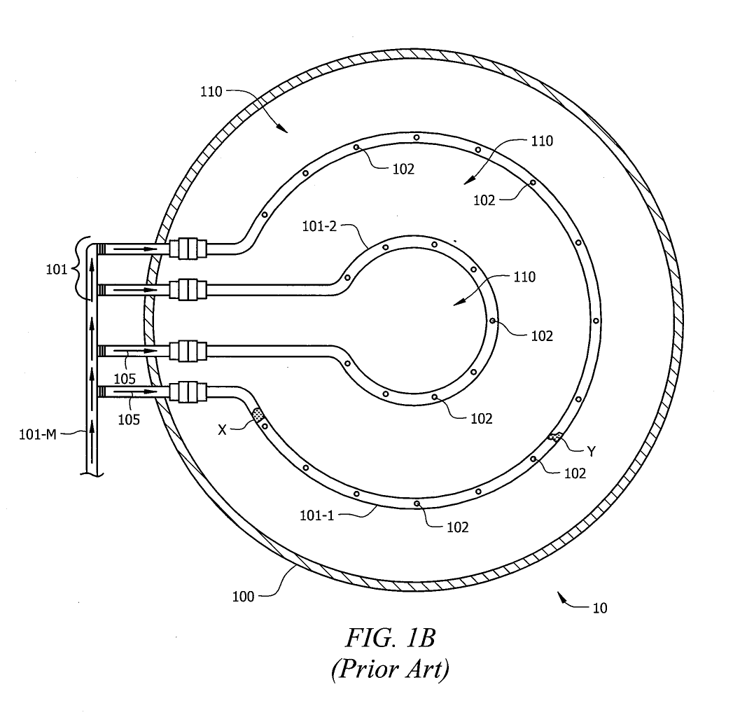

FIG. 1A shows a typical vaporizer, vaporizer 10, used in industrial plants. The design of vaporizer 10 may be used in various different processes. For purposes of the example embodiment described in FIGS. 1A and 1B, vaporizer 10 is used for vaporizing liquid ammonia in power plants. Power plants use ammonia vapor in a process known as selective catalytic reduction (SCR). SCR seeks to reduce the amount of nitrogen oxides emitted as a result of burning fossil fuels. Vaporizer 10 includes vessel 100, which has liquid injection rings 101 disposed within it. Liquid 105 flows from a storage vessel (not shown) through valve 109 through liquid injection rings 101 and into vessel 100. Liquid injection rings 101 include holes 102 through which liquid 105 is injected into open space 110 within vessel 100. From open space 110, liquid 105 falls onto poly-rings 112. Poly-rings 112 are typically made of metal and provide a large contact surface area for liquid 105. Poly-rings are supported in vessel 100 by sieve plate 113.

Concurrent with the injection of liquid 105 into vessel 100, blower 104 blows heating medium 106 into vessel 100 through inlet pipe 103. Heating medium 106 may be various different types of heated gas such as air, steam, flue gas or the like. As heating medium 106 rises, it passes through sieve plate 113, contacts and heats poly-rings 112 and liquid 105. Heating medium 106 will have a higher temperature than liquid 105 and poly-rings 112. Consequently, heat is transferred from heating medium 106 to liquid 105 directly and to poly-rings 212, which in turn supplies heat to liquid 105. As liquid 105 absorbs heat it vaporizes to form vapor 107 when the temperature reaches at least the boiling point of liquid 105. As vapor 107 is formed it rises and exits vessel 100 through outlet pipe 108. It should be noted that because of the large mass of material provided by poly-rings 112, it takes a long time for heating medium 106 to heat this large mass of material when vaporizer 100 is being started up from a cold state.

Turning to FIG. 1B, shown is a cross sectional plan view of vessel 100 that illustrates the configuration of liquid injection rings 101. Liquid injection rings 101 are circular in shape and concentric with the shape of vessel 100. This configuration is a typical method of packing liquid injection rings in vaporizers. Liquid 105 is introduced into vessel 100, typically as small droplets. Holes 102 form the mist of liquid droplets as liquid 105 flows through holes 102. As can be seen by the placement of holes 102, liquid 105 is dispersed by liquid injection rings 101 throughout open space 110.

Liquid injection rings 101 are typically made from metal and, depending on the properties of liquid 105, they may periodically require maintenance such as repairing ruptures, clearing blockages and the like. FIG. 1B shows liquid injection rings 101 including liquid injection ring 101-1 and liquid injection ring 101-2. Manifold 101-M feeds liquid to liquid injection rings 101. Because liquid injection ring 101-1 is a larger ring and has more holes than liquid injection ring 101-2, more of the flow of liquid 105 into vessel 100 likely takes place through liquid injection ring 101-1. If, for example, a blockage occurs at point X, shown in FIG. 1B, the normal flow of liquid 105 to vaporizer 10 via liquid injection ring 101-1 will be disrupted and possibly reduced. Furthermore, if a second blockage occurs at point Y, the combination of blockages at points X and Y would cause the total flow of liquid 105 into vessel 100 to drop significantly in view of the fact that liquid injection ring 101-1, in normal operation, likely injects more of liquid 105 into vessel 100 than injection ring 101-2. Clearing the blockages at points X and Y would generally require accessing liquid injection rings 101. Access to liquid injection rings 101 is usually achieved by removing top section 111 (FIG. 1A) from vessel 100 (FIG. 1A). Removing top section 111 (FIG. 1A), however, would necessitate taking vaporizer 10 completely out of service. Moreover, designing vaporizer 10 so that top section 111 can be removed significantly increases the cost of vaporizer 10. As such, the combination of having to take vaporizer 10 out of service for blockages and the cost of designing top section 111 removable makes vaporizer 10 a very expensive vaporizer design in terms of acquisition cost and maintenance.

Once top section 111 (FIG. 1A) is removed from vessel 100, liquid injection rings 101 may be repaired and/or cleaned. Alternatively, liquid injection rings 101 may be removed from vessel 100, repaired and/or cleaned outside of vessel 100 and returned to vessel 100. Again, this alternative maintenance process would entail taking vaporizer 10 completely out of service. This process of taking vaporizer 10 completely out of service to repair and/or clean it, as described above, is necessitated because of the configuration of vaporizer 10 and its liquid injection rings 101. Furthermore, if there is a need to, for example, double the amount of holes 102 on rings 101, the configuration of vaporizer 10 dictates that it would also have to be taken out of service to make such modifications.

Embodiments of the current disclosure seek to reduce the impact of maintenance on the operation of a vaporizer and, in turn, on the process in which the vaporizer is used. Additionally, the implementation of different hole distribution configurations in the vaporizer is more easily implemented in embodiments of the disclosure. Further, embodiments of the disclosure allow for additional functionalities such as vaporizing multiple liquids in one vaporizer and preheating the vaporizer.

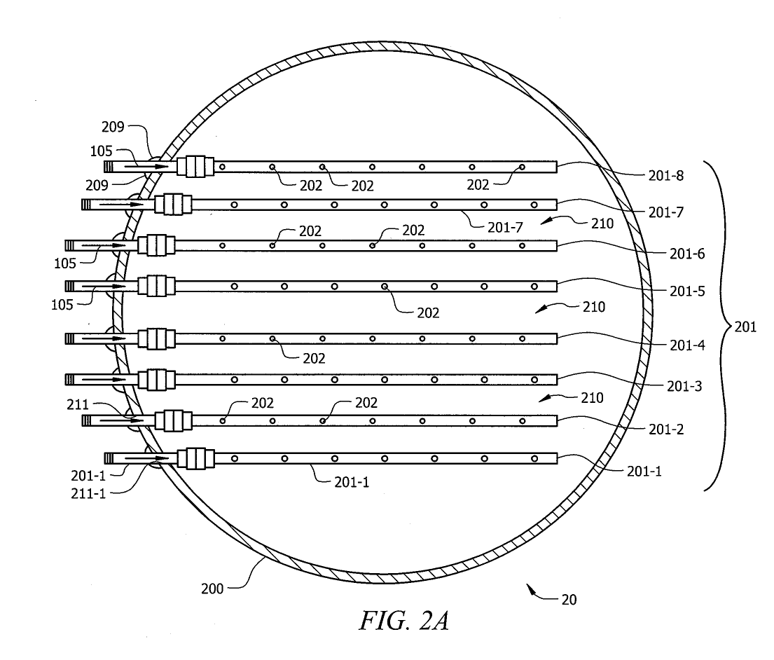

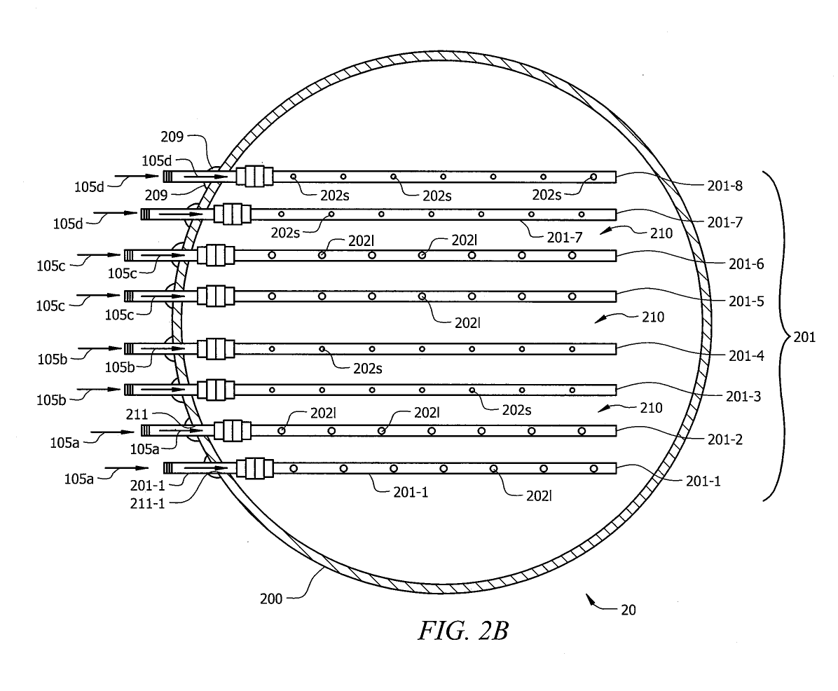

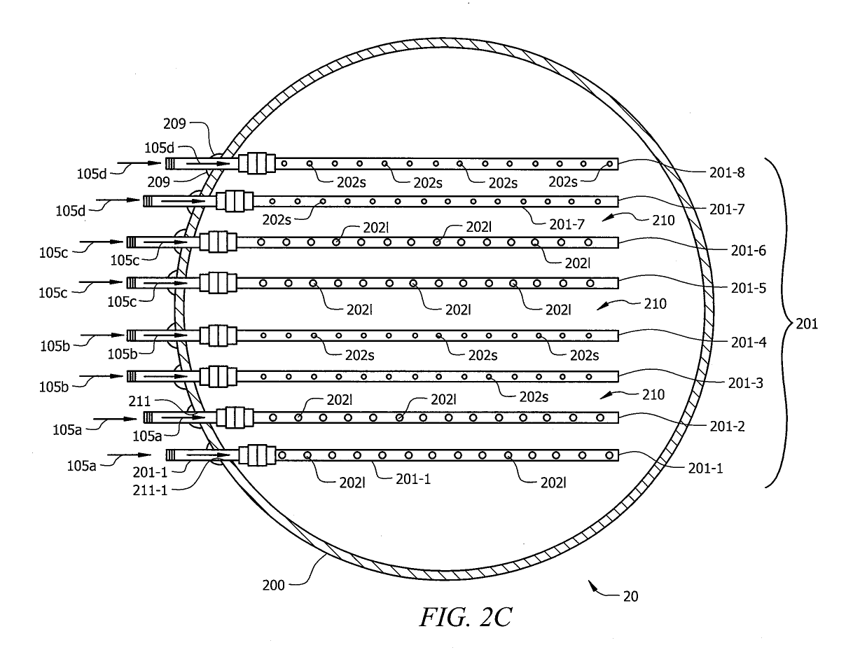

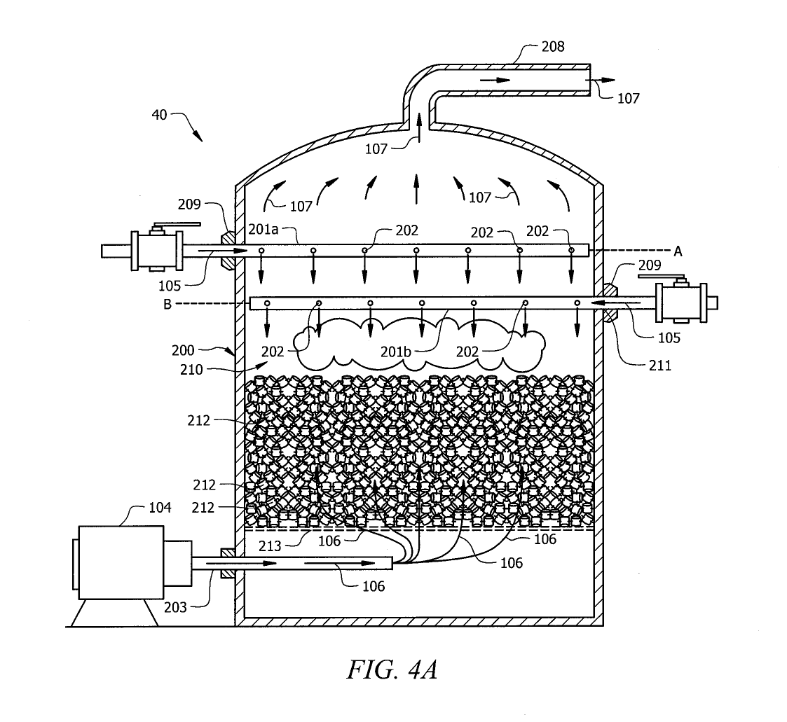

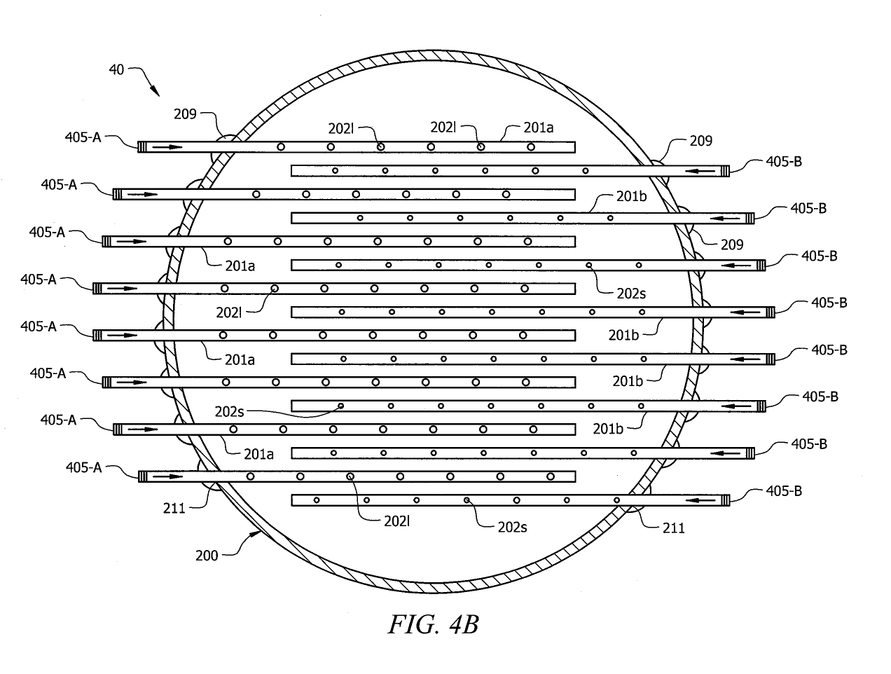

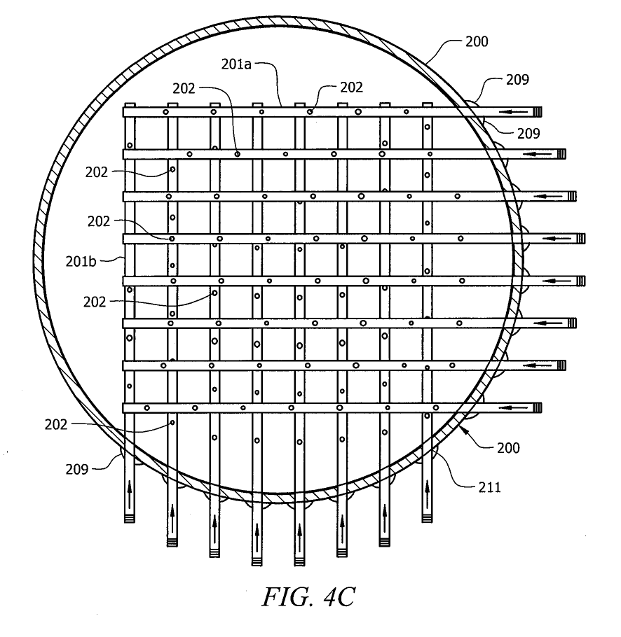

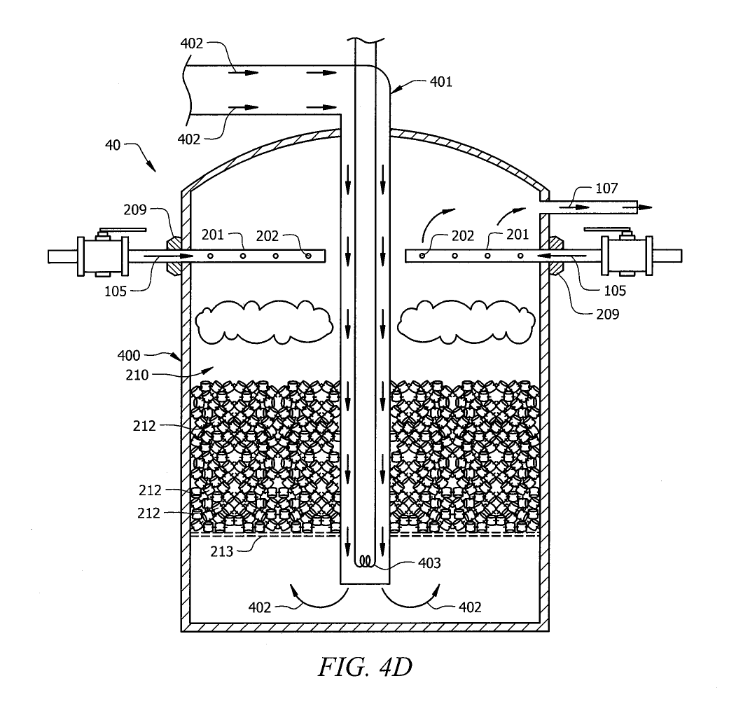

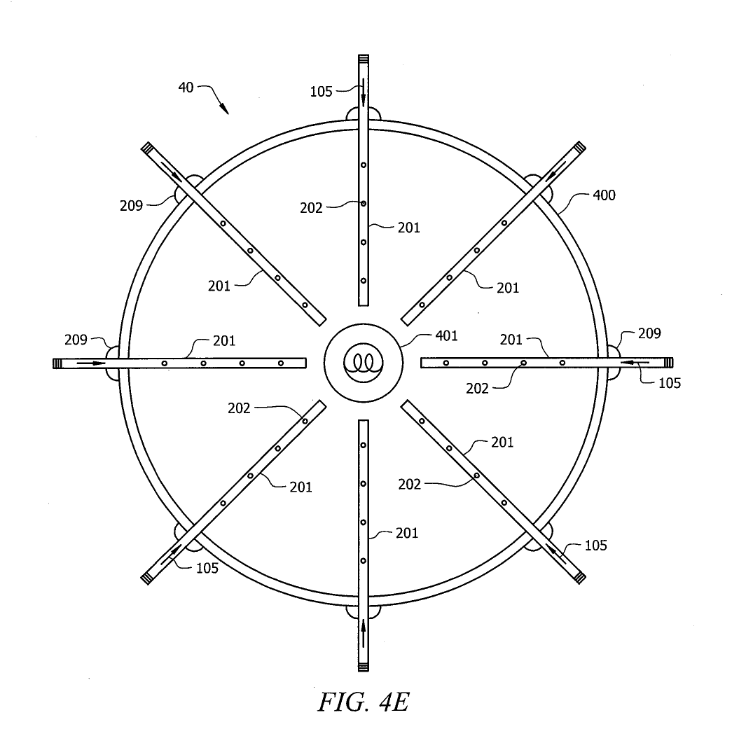

FIG. 2A shows a cross-sectional plan view of vaporizer 20 configured according to select embodiments of the disclosure. Liquid 105 flows to vaporizer 20 through lances 201 and is injected into vessel 200's open space 210 via holes 202 in lances 201. In this embodiment, lances 201 are straight hollow tubes that enter through the walls of vessel 200 via orifices 211. Lances 201 include lances 201-1-201-8. Lances 201 extend from the inside to the outside of vessel 200 when installed in vaporizer 20. Similar to the process described above with respect to vaporizer 10 blower 104 (FIG. 4A) blows heating medium 106 (FIG. 4A) into vessel 200 through inlet pipe 203, concurrent with the introduction of liquid 105 into vessel 200, as shown in FIG. 4A. As heating medium 106 rises, it contacts liquid 105 in open space 210 and transforms liquid 105 from liquid phase into vapor phase, that is, the heat transfer process transforms liquid 105 into vapor 107 (FIG. 4A).

In embodiments of the disclosure, such as shown in FIG. 2A, one or more of lances 201 may need repair. To illustrate, if lance 201-1 needs repair, instead of removing the top of vessel 200 to do the repair, as would be required for vaporizers with the configuration of vaporizer 10 (FIG. 1A), lance 201-1 is simply pulled out of vessel 200 through orifice 211-1 without disrupting the operation of vaporizer 20. Once lance 201-1 is removed, orifice 211-1 may be closed in various manners (described below) or even left open, depending on the type of operation of vaporizer 20. As such, vaporizer 20 may continue in service while lance 201-1 is being repaired outside of vaporizer 20. When lance 201-1 is repaired, it may be returned to operation by re-insertion through orifice 211-1.

Furthermore, embodiments of the disclosure, such as vaporizer 20, facilitate implementation of variations in the distribution of injection holes within the vessel of vaporizer 20. Indeed, any variation to a parameter of the fluid injection apparatus within vaporizer 20 is more easily implemented in embodiments of the current disclosure as compared with typical vaporizers. For example, vaporizer 10 (FIG. 1A) shows 24 injection holes 102. Changing the hole distribution by doubling the number of injection holes to 48 would entail major retrofitting of vaporizer 10, similar to the process described above for repairing rings 101. In contrast, varying the distribution of holes in vaporizer 20 would simply involve removing some or all of existing lances 201 and/or replacing the removed lance(s) with other lance(s) having the desired hole configuration. In fact, any change to the desired flow rate or flow distribution may be achieved by designing the appropriate number of lances for installation in vaporizer 20 or the distribution and/or size of any holes in the lances.

For example, in FIG. 2B, each of lances 201-1-201-8 has seven holes. Therefore, if it is desired to double the number of holes in vaporizer 20, lances 201-1-201-8 may be removed and replaced with lances having twice as many holes, as shown in FIG. 2C. Moreover, changes to hole distribution can be made to particular areas of the vessel by simply swapping out lances in the areas in question. In other words, changing the hole distribution at a particular area of a vessel simply requires changing the configuration of the lance serving that area of the vessel, in embodiments of the disclosure. As such, if plant process changes include changes to the injection apparatus in vaporizer 20, those changes could be implemented without taking vaporizer 20 out of service. It should be noted that in comparing vaporizer 20 (FIG. 2A) and vaporizer 10 (FIG. 1B), the holes in vaporizer 20 cover a wider cross sectional area of vessel 200. As such, lances 201 of vaporizer 20 provide for better hole distribution coverage than rings 101 of vaporizer 10. Because of the concentric circular shape of rings 101, the traditional vaporizer configuration is limited in its cross-sectional coverage area.

Apart from injection hole distribution, other parameters that may be changed easily according to embodiments of the disclosure include the rate of injection, length of fluid injection apparatus, cross sectional area of fluid injection apparatus, injection hole sizes and the like. Some of these parameters are interrelated and may be changed by merely changing the number of and/or the location of the injection holes in the vaporizer. For example, a change in the rate of injection may be accomplished by varying the number of injection holes in each lance. Alternatively or additionally, the rate of injection may be changed by changing the number of lances used in the vaporizer. Increasing the number of lances or changing the type of lances in vaporizer 20 is much easier than increasing the number of or making changes to rings in a typical vaporizer, such as vaporizer 10 (FIG. 1A). The relative ease with which changes to lances 201 can be made for vaporizer 20 is, at least in part, due to the ease with which lances 201 can be removed from vaporizer 20, as compared with the procedure for removing rings from vaporizer 10 (FIG. 1A).

As noted above, apart from facilitating maintenance and changes to a vaporizer without taking it out of service, embodiments of the disclosure provide several advantageous functionalities. One of these functionalities is the ability of a single vaporizer to vaporize multiple liquids. Referring again to FIG. 2B, for example, each of lances 201-1-201-8 may be used to introduce a different type of liquid into vessel 200 either concurrently or at different times. In some processes, it may be desirable to vaporize four different liquids, for example, to obtain a vapor mixture comprising the molecules of these different liquids. In FIG. 2B, if fluids 105a-105d are the four different liquids to be vaporized, these liquids can be introduced into vessel 200 using different lances, as shown. Specifically, fluid 105d may be introduced via lances 201-1 and 201-2, fluid 105b may be introduced via lances 201-3 and 201-4, fluid 105c may be introduced via lances 201-5 and 201-6 and fluid 105d may be introduced via lances 201-7 and 201-8 concurrently. As such, the configuration of vaporizer 20 provides the functionality whereby a vaporizer forms vapor from a plurality of different liquids.

In certain processes, vaporizer 20 may be used to vaporize different types of liquids in batches (i.e., not concurrently). For vaporization in batches, it may be desirable to introduce the different liquids through different lances based on the properties of the liquids. For example, fluid 105c may have a high viscosity, and thus, it is favorable to introduce it into vessel 200 through larger holes 2021 (FIG. 2B). In contrast, fluid 105b may have a low viscosity, and it may be favorable to introduce it through smaller holes 202s. Thus, to vaporize fluid 105c using vaporizer 20 (shown in FIG. 2B), all the lances may be easily changed to the configuration of lances with holes 2021 (i.e., changing lances 201-3, 201-4, 201-7 and 201-8). After this change, lances 201-1-201-8 (having holes 2021) will be ideally configured to introduce fluid 105c into vessel 200. Similarly, in a subsequent batch for vaporizing fluid 105b, by swapping out some lances, all the lances may be configured to have holes 202s and thereby all the lances would be ideal for introducing fluid 105b into vessel 200. As such, the ease with which lances may be changed in vaporizer 20 makes it is easy to switch vaporizer 20 from a configuration ideal to vaporizing one type of fluid to a configuration ideal to another type of fluid.

In some processes, vaporizer 20 may be used to vaporize different types of liquids in batches without replacing lances. In this scenario, particular lances are dedicated to introduce particular liquids into vessel 200. The vaporizing of the liquid can be selected by opening or closing the valves corresponding to the lances that feed the liquid selected. For example, considering the configuration of vaporizer 20 shown in FIG. 2B, to vaporize fluid 105c, the valves (not shown in FIG. 2B) on lances 201-5 and 201-6 may be opened to allow injection fluid 105c into vessel 200. The valves on all the other lances would be kept shut. Similarly, to vaporize fluid 105b, the valves on lances 201-3 and 201-4 may be opened, and the valves on all other lances kept shut, to allow injection of fluid 105b into vessel 200. As such, it is easy to switch vaporizer 20 from vaporizing one type of fluid to another by simply opening and closing valves on the lances.

Another functionality provided by embodiments of the disclosure includes the ability to preheat the vaporizer. Preheating may be desired in certain applications. For instance, ammonia vaporizers in power plants should become operational quickly, at start up, so as to place the SCR process quickly into efficient operation. The SCR process affects the ability of the plant to reduce hazardous emissions, thereby keeping the plant in compliance with environmental regulations. Depending on the geographical location of the plant, the maximum amount of time allowed by environmental regulations for the SCR process to be out of compliance while heating up may be as little as ten minutes. In this scenario, the ammonia vaporizer should, therefore, be producing a sufficient amount of ammonia vapor in less than ten minutes from start up. Preheating the vaporizer is one way of reducing the start up time for the ammonia vaporizer and the SCR process to reach operational levels.

Embodiments of the disclosure provide methods of rapidly getting vaporizers operational from start up. For example, some embodiments of the disclosure provide efficient ways of preheating vaporizers. Vaporizer 20 may be configured to have some lances introduce a heating medium into vessel 200 prior to introduction of liquid ammonia into vessel 200. The introduction of heating medium via lances is supplemental to the regular heat supplied from the heating medium 106 through inlet pipe 103 at the bottom of vessel 200 (FIG. 4A). A supplemental heat source may be necessary when the heat supply from heating medium 106 is not adequate to achieve the rate of heating required. In other words, in some instances, it may take too long to reach operational temperature if heating medium 106 is used as the only source of heat. Referring to FIG. 2C, fluid 105a and 105c may be ammonia while fluid 105b and 105d may be a heating medium such as hot air. In this configuration, hot air enters space 210 via lances 201-3, 201-4, 201-7 and 201-8 and preheats vaporizer 20 prior to introduction of ammonia into vessel 200. With vaporizer 20 preheated, liquid ammonia may then be introduced into vessel 200 via lances 201-1, 201-2, 201-5 and 201-6. The vessel reaches its operational temperature faster with both the regular source and the supplemental pre-heater. Lances 201-3, 201-4, 201-7 and 201-8 may introduce hot air for any period during the operation of vaporizer 20. However, in some instances, when the temperature of vaporizer 20 is sufficiently high, some or all of lances 201-3, 201-4, 201-7 and 201-8 may be switched from introducing hot air to introducing ammonia in vessel 200.

Still referring to FIGS. 2C and 4A, other embodiments of the disclosure may use hot flue gas as heating medium 106 entering through inlet pipe 203. A stream of this flue gas, which in some instances may be as hot as 1000° F., may be injected into vessel 200 above poly-rings 212 via, for example, lances 201-3, 201-4, 201-7 and 201-8. Concurrent with the injection of the hot flue gas, liquid ammonia may be injected into vaporizer 200 via lances 201-1, 201-2, 201-5 and 201-6. In this scenario, during a cold start up, while heating medium 106 from inlet pipe 203 is heating up poly-rings 212 to an operational temperature, heating medium 106 (via lances 201-3, 201-4, 201-7 and 201-8) may be heating and vaporizing ammonia above poly-rings 212. As such, vaporization of ammonia is not completely dependent on poly-rings 212 reaching the operational temperature.

Another embodiment of the disclosure involves heating ambient air to a desired temperature and using the heated air as heating medium 106. Referring to FIG. 4A, in this embodiment of the disclosure, an electric heater (not shown) may be placed between blower 104 and vessel 200. Blower 104 would supply ambient air to the electrical heater, which would heat the air to the desired temperature. The heated air would then heat poly-rings 212 and vaporize liquid 105. In another embodiment of the disclosure, heated air could be injected above poly-rings 212 to vaporize liquid 105 without necessarily heating poly-rings 212 to the operational temperature.

In sum, embodiments of the disclosure facilitate reaching operational temperatures more quickly, which, in the case of ammonia vaporization units, brings the plant into environmental compliance more quickly.

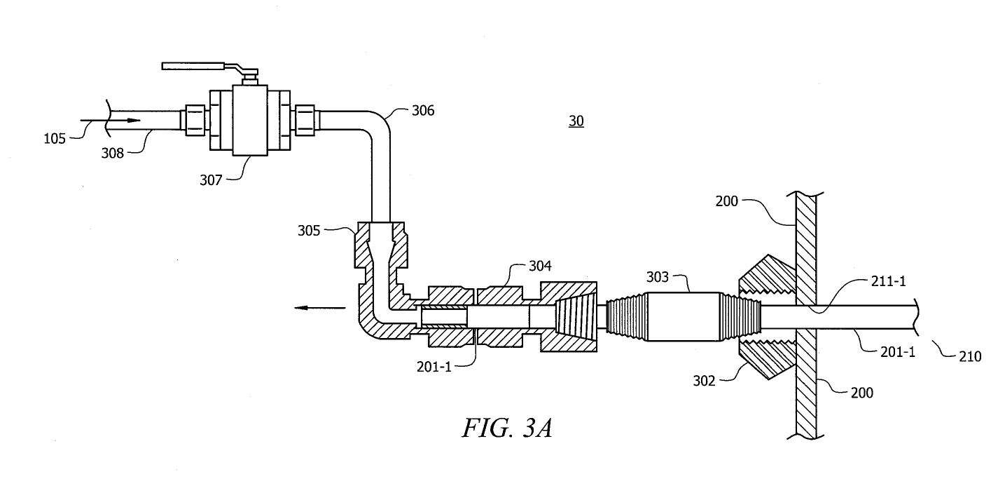

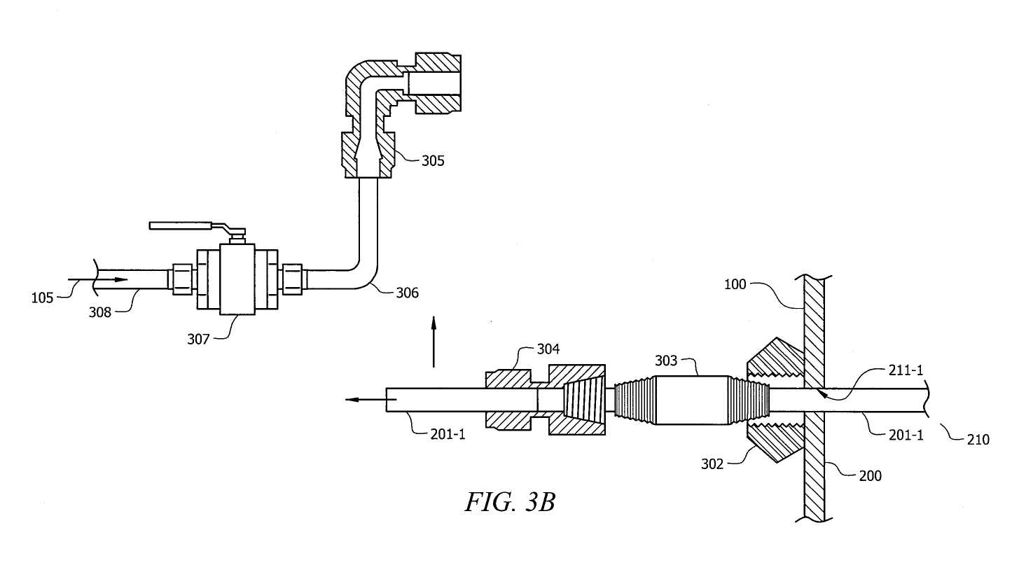

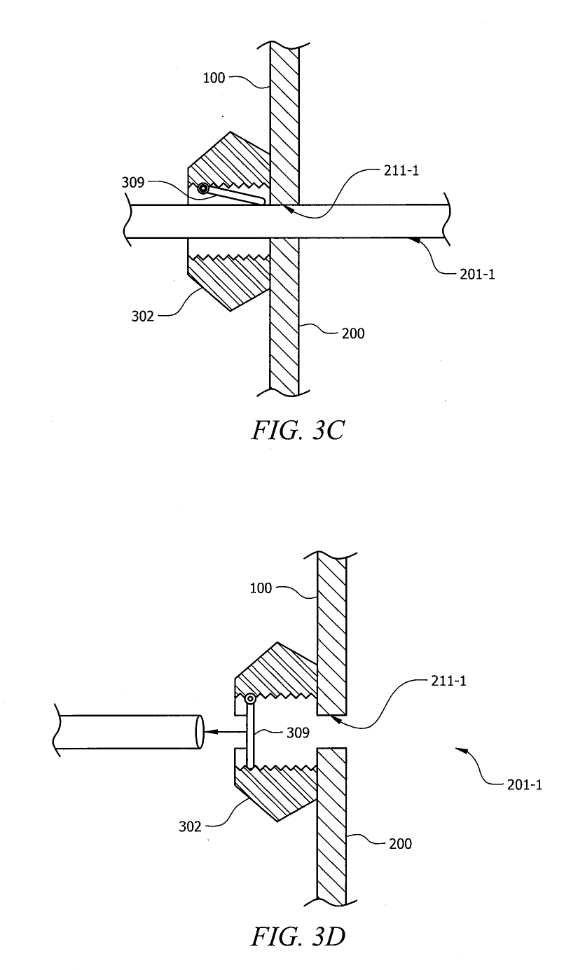

Described above are embodiments of the disclosure that include vaporizers with lances that extend from inside to outside of a vessel. Expected operations of various embodiments of the disclosure involve removing these lances for maintenance or cleaning. FIGS. 3A-3D show equipment according to select embodiments of the disclosure that couple the lances to the vaporizer and the substances to be injected therein. Referring now to FIG. 3A, equipment 30 may be used to deliver liquid 105 to vessel 200, to facilitate the removal of lance 201-1 from vessel 200 and to seal orifice 211-1. Lance 201-1 extends from elbow 305 through device 304, pipe 303, device 302 and orifice 211-1 into open space 210 of vaporizer 20. Device 302 is attached to the wall of vessel 200. Device 302 is configured to receive and couple to one end of pipe 303. Device 302 and pipe 303 may be coupled together by a screw and thread mechanism but other coupling methods may also be used. The other end of pipe 303 is coupled to device 304 (e.g., by screw and thread). In turn, device 304 is coupled to elbow 305 by a detachable coupling (not shown). Elbow 305 is connected to valve 307 by elbow pipe 306 and valve 307 regulates the flow of liquid 105 from its source to elbow 306 and eventually into vessel 200.

Because elbow 305 is detachable from device 304, when it is desirable to remove lance 201-1, valve 307 is closed to stop the flow of liquid, after which elbow 305 is detached from device 304 and then pushed away from and out of the direction of lance 201-1, as shown in FIG. 3B. As such, lance 201-1 can be removed from vessel 200. Once lance 201-1 is removed, elbow 305 may be reconnected to device 304 in order to seal the vaporizer environment. During and after the removal of lance 201-1, it may be desirable to keep valve 307 closed. Closing valve 307 prevents any flow of material through orifice 211-1 i.e., effectively sealing orifice 211-1. Lance 201-1 can then be repaired outside of vaporizer 20. Significantly, while lance 201-1 is being repaired, vaporizer 20 may still be kept in service to vaporize liquid 105 because there are several other lances in service that are capable of injecting sufficient liquid 105 into vessel 200. After the repair of lance 201-1, it can be returned to service by detaching elbow 305 from device 304, moving elbow 305 away from device 304 and inserting lance 201-1 into device 304 until it is properly positioned in vessel 200.

Referring to FIGS. 3C and 3D, shown are embodiments of the disclosure that provide a mechanism for automatically sealing orifice 211-1 when lance 201-1 is removed from vessel 200. In this embodiment of the disclosure, device 302 includes a self closing gate 309. In FIG. 3C, self closing gate 309 is shown in contact with the upper portion of lance 201-1 when orifice 211-1 is open and lance 201-1 extends through it. Self-closing gate 309 includes a self-closing mechanism (not shown), which applies a downward force onto closing gate 309 and in turn onto lance 201-1. FIG. 3D shows lance 201-1 removed from vessel 200. On the removal of lance 201-1 from vessel 200 and orifice 211-1, the downward force on self-closing gate 309 causes it to close behind lance 201-1 and seal orifice 301. As such, self-closing gate 309 prevents or limits the escape of fluids or vapor from vessel 200.

Referring now to FIGS. 4A-4E, shown are variations of embodiments of the disclosure. FIG. 4A is a cross sectional elevation view of vaporizer 40, which shows an aspect of the disclosure that includes multiple lances on different horizontal planes within vessel 200. As shown in FIG. 4, one group of lances may be placed on horizontal plane A and another may be placed on horizontal plane B. Any number of horizontal planes may be utilized. Moreover, the lances placed in different planes may be so configured that no lance lies directly below or above another. Instead, the lances of one plane may be interspersed with the lances of another plane. Injection of liquids into vessel 200 on different planes may be advantageous in improving the distribution of liquid in vaporizer 40. Further, it may allow for more efficient heat exchange between the heating medium and the liquid being vaporized. Further yet, lances on one plane may be used to introduce a heating medium to pre-heat the vaporizer while lances in another plane later inject liquid to be vaporized. In this scenario, after the pre-heating process, pre-heating lances may be switched from introducing the heating medium to introducing liquid to be vaporized.

FIG. 4B shows a cross sectional plan view of vaporizer 40 having lances on different planes interspersed with each other. Specifically, lances 201a are shown interspersed with lances 201b such that none of lances 201a and 201b are directly above or below each other. In embodiments of the disclosure, fluids 405-A and 405-B may be different fluids. For example 405-A and 405-B may be different liquids to be vaporized or 405-A may be a liquid to be vaporized and 405-B may be a heating medium, such as hot air, steam or hot flue gases and the like. It should be noted that the lances 201a include holes 2021 that are larger than holes 202s of 201b. As discussed above, the difference in the size of the holes may be a function of the properties of the fluid 405-A and 405-B. For example, holes 2021 may be more appropriate if fluid 405-A has a high viscosity. Conversely, holes 202s may be more appropriate for fluids with low viscosity.

FIG. 4C shows yet another configuration according to select embodiments of the disclosure. As shown in FIG. 4C, lances may be arranged on different planes perpendicular to each other.

FIGS. 4D and 4E show another embodiment of the disclosure. In some vaporizers, such as vaporizer 40, heat may be provided by an in-line heater such as electrical heater 401 having heating element 403 that heats air 402, which is initially at ambient temperature, as it flows through electrical heater 401 and into vessel 400. Hot air 402 then heats poly-rings 212 (not shown in FIG. 4E but shown in FIG. 4D) and liquid 105 resulting in the vaporization of liquid 105. As shown with respect to vaporizer 40, in some instances, the heating equipment is placed in the center of the vaporizer. As such, the configuration of lances 201 shown in FIG. 4E is ideal for accommodating heating design of vaporizer 40. Moreover, some of lances 201 shown in FIG. 4E may be used to inject heating medium into vessel 400 above poly-rings 212 while other lances 201 inject liquid 105. This configuration provides a method for vaporizing liquid 105 even if poly-rings 212 are not at the operational temperature.

Based on the configurations shown in FIGS. 4A-4E and their respective descriptions, it is clear that embodiments of the disclosure may include different configurations of lances 201 within a vessel. Further, it should be noted that the configuration employed in a particular vaporizer may be a function of the type of liquid being vaporized, the heating medium being used, the rate of vaporization required, and the like. The various embodiments of the present disclosure are not limited to any specific configuration of vaporizer or any specific configuration of lances.

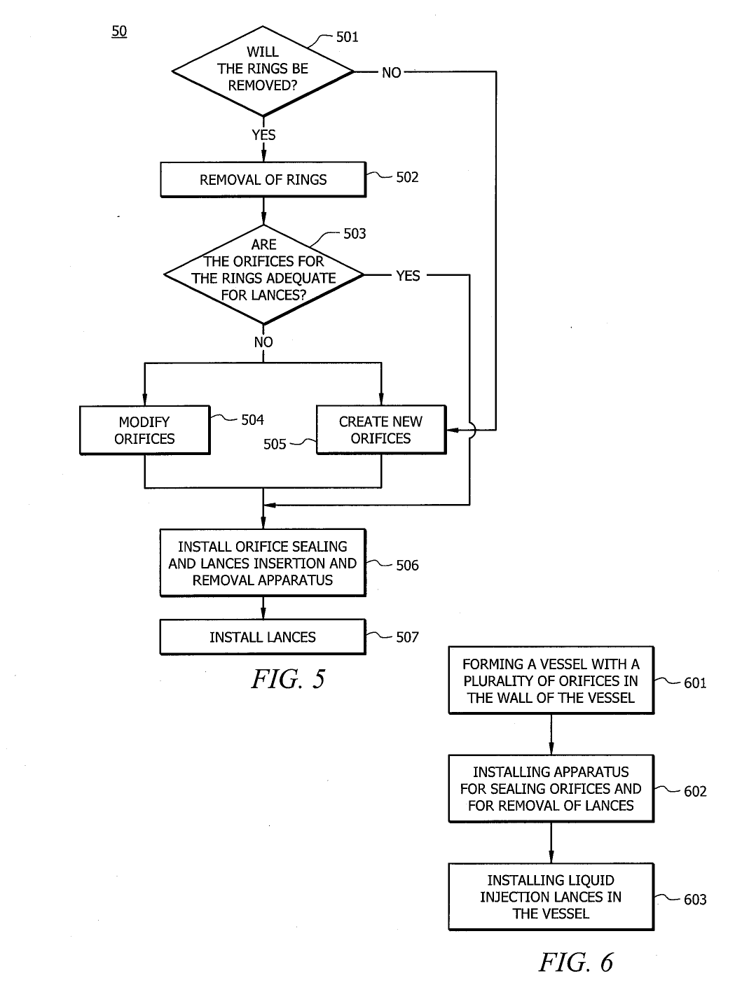

Turning now to FIG. 5, shown is process 50 defined according to select embodiments of the disclosure. Process 50 includes multiple functional blocks that may be executed in retrofitting a vaporizer with lances according to various embodiments of the disclosure. A vaporizer may have, for example, liquid injection rings for injecting liquid into the vaporizer as described with respect to FIGS. 1A-1B. In order to retrofit such a vaporizer, at block 501, it is determined whether the liquid injection rings will be removed. That is, to retrofit a vaporizer with lances according to embodiments of the disclosure does not necessarily require the removal of the liquid injection rings. Instead, the liquid injection rings may be taken out of service and lances added to the vaporizer. If the liquid injection rings are not removed, then, at block 505, new orifices are created.

If the liquid injection rings are to be removed, this is done at block 502. At block 503, it is determined whether the orifices for the liquid injection rings are adequate for the lances. If not, at blocks 504 the orifices may be modified in terms of shape or size. Alternatively or additionally, block 505 may include creation of new orifices. Block 506 involves the installation of apparatus shown in FIGS. 3A-3D, which may be used to seal the orifices of the vessel and facilitate insertion and removal of the lances into and from the vessel. At block 507, the lances are installed in the vessel through the orifices provided (existing, modified or new). It should be noted that not all the blocks of process 50 are required in embodiments of the disclosure. Some embodiments of the disclosure may involve execution of the blocks in different order than that described with respect to process 50. For example, the installation of orifice sealing and lance insertion and removal apparatus (block 506) may be performed at any point in process 50 such as after block 507 or before block 501.

FIG. 6 shows process 60 defined according to select embodiments of the disclosure. Process 60 is a method for constructing a vaporizer. At block 601, a vessel is formed with multiple orifices. The vessel may be formed with the orifices or the vessel may be formed and then the orifices created by, for example, drilling, cutting, etc. At block 602, apparatus for sealing the orifices and for facilitating the insertion and removal of the lances is installed. Fluid delivery lances are removably installed in the vessel at block 603. It should be noted that not all the blocks of process 60 are required in embodiments of the disclosure. Some embodiments of the disclosure may involve execution of the blocks in different order than that described with respect to process 60. For example, installation of lances (block 603) may be performed before the installation of orifice sealing and lance insertion and removal apparatus (block 602).

In various embodiments of the disclosure the size and shape of orifices 211 are a function of the size and shape of the lances. In other words, orifices 211 are made just large enough to allow easy insertion and removal of lances 201 into and from vessel 200. That is, the area and shape of orifices 211 may be based on the cross sectional area and shape of lance 201. It should be noted that the cross sectional areas of lances can have shapes such as circular, elliptical, square, rectangular, oblong, and the like, and the various embodiments are not limited to any particular shape of lance.

Lances, vessels and other vaporizer equipment of embodiments of the disclosure may be made from any suitable materials known by those skilled in the art including metals, plastic, and the like. It should also be noted that though the vessel shape described herein is a hollow vertical cylinder embodiments of the disclosure may be implemented in vessels of different shape and orientation such as a cube, a cuboid (in a vertical or horizontal orientation) and the like.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A vaporizer comprising:
a vessel having a plurality of orifices in a wall of said vessel; and
a plurality of fluid delivery lances disposed within said vessel, wherein at least one of said lances is configured for removal from said vessel through at least one of said orifices and wherein said at least one orifice is configured to have said at least one lance extending through said at least one orifice into said vessel.

2. The vaporizer of claim 1 further comprising:
an inlet pipe for delivering a heating medium to said vessel.

3. The vaporizer of claim 1 further comprising:
apparatus connected said at least one of orifice for sealing said at least one orifice when said at least one lance is removed.

4. The vaporizer of claim 1 wherein said vessel is a vertical cylindrical column.

5. The vaporizer of claim 4 wherein said fluid delivery lances are disposed at different vertical planes within said vessel.

6. The vaporizer of claim 1 wherein said fluid delivery lances comprise different size holes through which a liquid for vaporization flows into said vessel.

7. The vaporizer of claim 1 wherein said orifices are adapted to be sealed during operation of said vaporizer.

8. The vaporizer of claim 1 wherein said fluid delivery lances are tubes having a cross section selected from the list consisting of: circular, elliptical, square, rectangular and oblong.

9. A method of retrofitting a vaporizer, said method comprising:
installing fluid delivery lances in said vessel, wherein at least one of said lances is configured for removal from said vessel through at least one of a plurality of orifices in a wall of said vessel and wherein said at least one orifice is configured to have said at least one lance extending through said at least one orifice into said vessel.

10. The method of claim 9 further comprising:
creating orifices in a vessel of said vaporizer.

11. The method of claim 9 further comprising:
removing at least one ring delivery tube from said vessel.

12. The method of claim 9 further comprising:
installing apparatus to at least one of said orifices for sealing said at least one orifice when said at least one lance is removed.

13. The method of claim 9 wherein said vessel is a vertical column.

14. The method of claim 13 wherein said fluid delivery lances are installed at different vertical planes within said vessel.

15. The method of claim 9 wherein said fluid delivery lances comprise holes through which a liquid for vaporization flows into said vessel.

16. The method of claim 9 wherein said orifices are adapted to be sealed during operation of said vaporizer.

17. The method of claim 9 wherein said fluid delivery lances are tubes having a cross section selected from the list consisting of: circular, elliptical, square, rectangular and oblong.

18. A method of making changes to equipment within a vaporizer; said method comprising:
removing at least one injection lance disposed within said vaporizer through at least one of a plurality of orifices in a wall of said vaporizer, wherein said at least one orifice is configured to have said at least one lance extending through said at least one orifice into a vessel of said vaporizer; and
modifying functional characteristics of said at least one injection lance according to the intended change to said equipment.

19. The method of claim 18 wherein said modifying comprises:
replacing said lance with a new lance having a different configuration than said removed lance.

20. The method of claim 19 wherein said modifying comprises changing parameters of said at least one injection lance, said parameters selected from the list consisting of: type of material of lance, number of holes in lance, length of lance, size of holes in lance, distribution of holes in lance, cross sectional shape of lance and combinations thereof.

21. The method of claim 18 wherein said modifying comprises:
repairing said removed lance and returning said removed lance to said vaporizer.
